(19) United States
(12) Patent Application Publication
(10) Pub. No.: US 2007/0253222 A1
(43) Pub. Date: Nov. 1, 2007

(54) Nightlight with rotatable image drum

(75) Inventors: John Driska, Princeton Junction, NJ (US); Gary Michael Schwartz, Manalapan, NJ (US); Thomas Waifung Choi, Edison, NJ (US)

Correspondence Address: OSTROLENK FABER GERB & SOFFEN, 1180 AVENUE OF THE AMERICAS, NEW YORK, NY, 100368403, US

(73) Assignee: SDI Technologies, Inc.

(21) Appl. No.: 11/430,633

(22) Filed: Apr. 27, 2006

(51) Int. Cl. H01R 33/00

(52) U.S. Cl. 362/641

(57) ABSTRACT

A nightlight according to the invention may comprise a base; a lighting device on the base; and a power source in the base for the lighting device; an outer housing mounted on the base and surrounding the lighting device, having a window through which light can project from the lighting device; an image support within the outer housing for holding at least one image between the lighting device and the window, whereby the image is illuminated by the lighting device and visible through the window. The image support may be rotatably mounted within the outer housing, and capable of supporting a plurality of images and of being selectively rotated into a position for displaying a selected one of the images through the window. The image support may be a cylindrical drum. The image support may be rotatable by a ring which is accessible by a user for manually rotating the drum. The image may be a pictorial image or may be formed by perforations formed in the image support. The image support may be transparent, translucent or opaque. The lighting device may comprise a light bulb or an LED and may have a light-spreading or diffusing arrangement associated with the lighting device.

### BACKGROUND OF THE INVENTION

The present invention relates to a nightlight, and more particularly to a night light having a rotatable drum for displaying an illuminated image.

### SUMMARY OF THE INVENTION

The present invention provides a nightlight which is adapted for receiving and displaying an image selected by the user. The nightlight is better able than known nightlights to satisfy the user's esthetic requirements.

A nightlight according to the invention may comprise a base; a lighting device on the base; and a power source in the base for the lighting device; an outer housing mounted on the base and surrounding the lighting device, having a window through which light can project from the lighting device; an image support within the outer housing for holding at least one image between the lighting device and the window, whereby the image is illuminated by the lighting device and visible through the window. The image support may be rotatably mounted within the outer housing, and capable of supporting a plurality of images and of being selectively rotated into a position for displaying a selected one of the images through the window. The image support may be a drum, which may for example be cylindrical or polygonal in its cross-section. The image support may be rotatable by a ring which is accessible by a user for manually rotating the drum. The image may be a pictorial image or may be formed by perforations formed in the image support. The image support may be transparent, translucent or opaque. The lighting device may comprise a light bulb or an LED and may have a light-spreading or diffusing arrangement associated with the lighting device.

Other features and advantages of the present invention will become apparent from the following description of embodiments of the invention which refers to the accompanying drawings.

### BRIEF DESCRIPTION OF THE DRAWINGS

FIG. 1 is a perspective view of a nightlight according to a first embodiment of the invention.

FIG. 2 is a perspective view of an outer housing in the first embodiment.

FIG. 3 is a cross sectional view of the first embodiment.

FIGS. 4 and 5 are respectively a partial perspective view and a partial detail showing parts of a second embodiment of the invention.

FIG. 6 is an exploded view of a third embodiment.

FIG. 7 is an isometric view of a top lid of the third embodiment.

### DETAILED DESCRIPTION OF EMBODIMENTS OF THE INVENTION

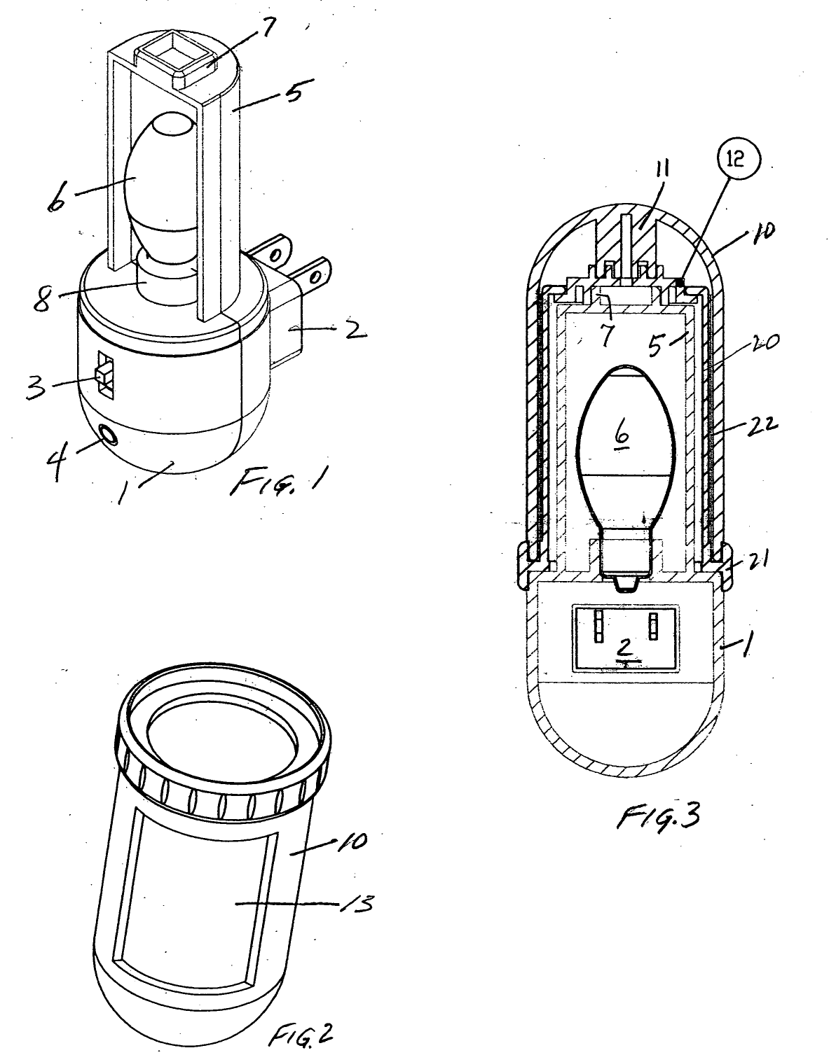

FIG. 1 is a perspective view of a first example of a nightlight embodying the invention. A first part of the nightlight comprises a base 1, which includes an electric plug 2, an On-Off-Auto or optionally Off/Auto switch 3, and a CdS photocell sensor 4. As the foregoing parts are conventional, no further description is needed.

A second part of the nightlight includes an inner housing 5 which houses a light bulb 6 mounted on a lamp base 8. The inner housing 5 is generally half-cylindrical and has on its distal end a mounting part 7 which will be described further below.

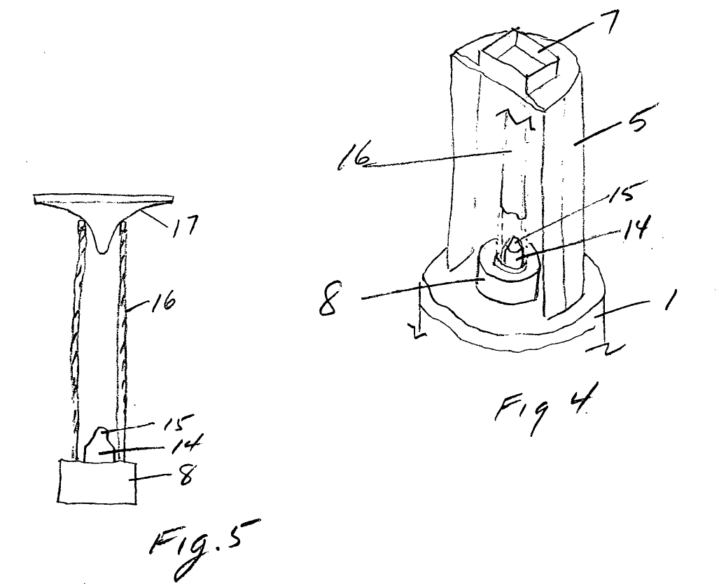

The second part further includes an outer housing 10, shown in perspective view in FIG. 2 and in cross-section in FIG. 3. Inside the distal end of the outer housing 10 is an inwardly projecting spacer 11. The spacer 11 engages the mounting part 7 of the inner housing 5 via a mounting plate 12, seen in cross-section in FIG. 3. Thus, the outer housing 10 is linked and held in fixed relation with the inner housing 5 and the base 1. The mounting frame 5, spacer 11, and mounting plate 12 may take any suitable shape as long as they perform their function of holding the outer and inner housings and the base in fixed relation to each other.

As best seen in FIG. 2, the outer housing 10 has a window 13 which is preferably on a side thereof facing outwardly from the base 1, and away from the electrical plug 2, in a position corresponding to the open side of the half-cylindrical inner housing 5.

As seen in FIG. 3, the second part of the nightlight further includes a cylindrical drum 20, which is mounted between the inner and outer housings 5, 10 and rotatable by a knurled ring 21. Either attached to or formed integrally with the drum 20 is a layer or film 22 which bears at least one and preferably several images.

The drum need not be cylindrical, but may for example be polygonal in cross-section.

The drum also need not be rotatable coaxially with the base as shown, but may be placed in any other orientation as desired. Further, the images need not be placed on a drum, but may for example be placed on a flat structure, such as a disk, arranged suitably on the base so as to face into the room.

As thus arranged, the lamp 6 illuminates the open window 13 in the outer housing 10. The cylindrical drum 20 in the outer housing 10 is manually rotatable by means of the knurled ring 21 past the window 13. The drum 20 is translucent or transparent and has at least one and preferably several images formed as a film 22 on the drum, such that rotation of the drum places an image in the window 13 which is illuminated by the lamp 6, whereby the image is visible through the window 13. The knurled ring 21 is connected with the drum 20 to rotate the drum inside the stationary outer housing 10.

The image need not be a photographic or pictorial image, but may for example be formed by perforations in the form of dots or a stencil-like pattern in an opaque or translucent film 22. In this case the image will be visible when looking at the nightlight and will also be projected outward into the surrounding room.

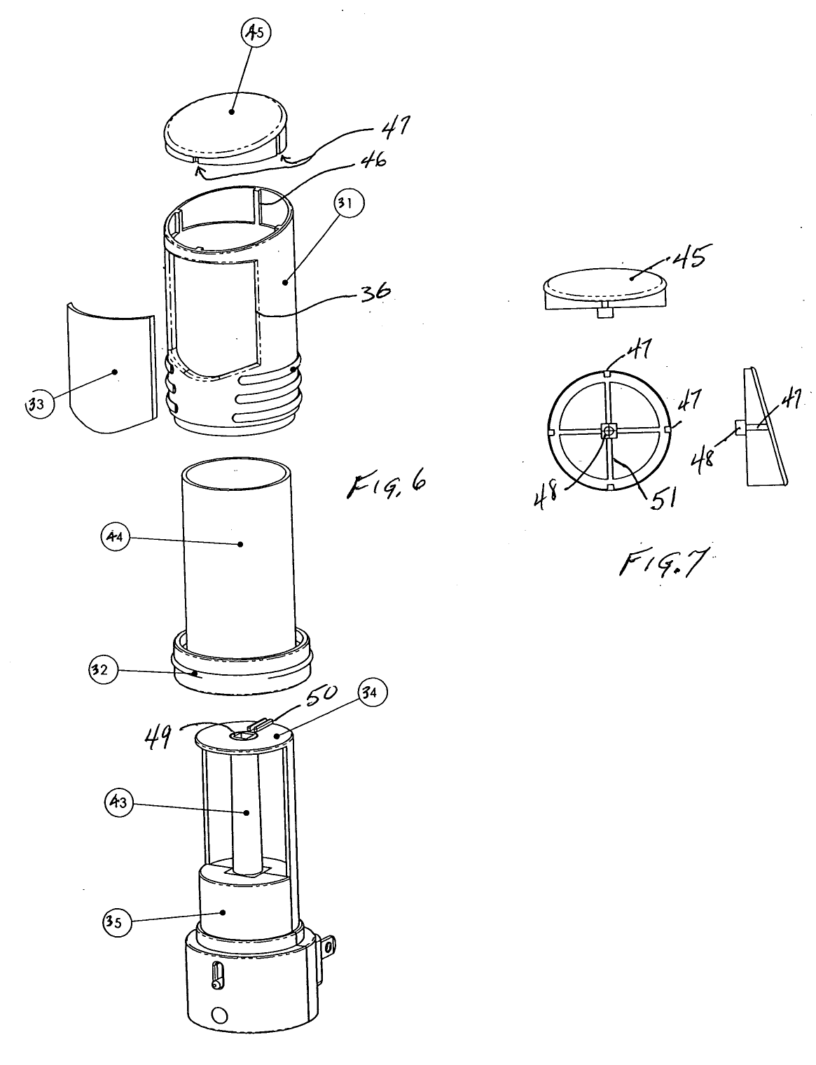

A second embodiment of the invention comprising a different lighting device is shown in FIG. 4. In this embodiment the light source 14 comprises an LED housed in a transparent envelope which may optionally include an upward-directed focusing lens 15. Enclosing the light source 14 is a translucent cylindrical diffuser 16 which extends away from the light source 14 within the inner housing 5 and is secured by any suitable means. The light from the LED is directed upward by the lens 15 and is diffused and spread by the translucent diffuser 16. As shown in FIG. 5, an optional reflector 17 may also be provided, at the distal end of the diffuser 16, for reflecting outward and diffusing the light that passes axially directly through the cylindrical diffuser 16.

A third embodiment of the invention is shown in an exploded view in FIGS. 6 and 7. A base 35 has an LED (not shown), a power source, a switch and a photocell as in the other embodiments. A translucent light pipe 43 conducts light upward from the LED within an inner housing 34.

A drum 44 for supporting images can be slid down concentrically over the inner housing 34 and is manually rotatable about the inner housing 34 via a ring 32. The ring 32 rests on a shoulder of the base 35.

An outer housing 31 in turn can be slid down concentrically over the drum 44. A top lid 45 fits into the top of the outer housing 31 and the top lid and the outer housing are held in fixed relation by a plurality of ridges 46 and grooves 47.

As shown in FIG. 7, the top lid 45 further has a profiled projection 48, which is square in cross-section in this example, and engages a recess 49 having a like cross-section formed in the top of the inner housing 34. The top of the inner housing 34 further has an upward-facing channel 50 which engages a ridge 51 formed on the underside of the top lid 45.

Thus the outer housing 31 is secured in fixed relation to the inner housing 34, while the image-supporting drum 44 is disposed concentrically in between the outer and inner housings, and is manually rotatable via the externally-accessible ring 32.

A lens 33 covers a window 36 through which images on the drum 44 can be viewed.

Although the present invention has been described in relation to particular embodiments thereof, many other variations and modifications and other uses will become apparent to those skilled in the art. Therefore, the present invention is not limited by the specific disclosure herein.

What is claimed is:

1. A nightlight comprising:
a base;
a lighting device;
an outer housing mounted on the base and surrounding the lighting device, having a window through which light can project from the lighting device;
an image support within the outer housing for holding at least one image between the lighting device and the window, whereby the image is illuminated by the lighting device and visible through the window.

2. The nightlight of claim 1, wherein said image support is rotatably mounted within the outer housing, and is capable of supporting a plurality of images and of being selectively rotated into a position for displaying a selected one of said images through the window.

3. The nightlight of claim 2, wherein said image support is a drum and rotates about an axis thereof.

4. The nightlight of claim 3, wherein said drum is cylindrical.

5. The nightlight of claim 3, wherein said image supporting drum is rotatable by a ring linked to the drum and arranged circumferentially of said outer housing, the ring being accessible by a user for manually rotating the drum.

6. The nightlight of claim 1, wherein said image is a pictorial image disposed on the image support.

7. The nightlight of claim 1, wherein said image support is transparent.

8. The nightlight of claim 1, wherein said image support is translucent.

9. The nightlight of claim 8, wherein said image is formed by perforations formed in the image support.

10. The nightlight of claim 1, wherein said image support is opaque and said image is formed by perforations formed in the image support.

11. The nightlight of claim 1, wherein said lighting device comprises a light bulb.

12. The nightlight of claim 1, wherein said lighting device comprises an LED.

13. The nightlight of claim 12, further comprising a light-spreading and/or diffusing arrangement associated with said LED within the outer housing.

14. The nightlight of claim 1, wherein the lighting device is on the base.

15. The nightlight of claim 14, wherein the base further comprises a power source for the lighting device.
